(19) United States
(12) Patent Application Publication
(10) Pub. No.: US 2022/0138790 A1
(43) Pub. Date: May 5, 2022

(54) DYNAMIC TIME-BASED ADJUSTMENT OF PREDICTIVE MODELING DATA

(71) Applicant: GROUPON, INC., Chicago, IL (US)

(72) Inventors: Kevin Chang, Mountain View, CA (US); Amber Roy Chowdhury, Bellevue, WA (US)

(21) Appl. No.: 17/574,514

(22) Filed: Jan. 12, 2022

Related U.S. Application Data
(63) Continuation of application No. 14/675,125, filed on Mar. 31, 2015.
(60) Provisional application No. 61/973,815, filed on Apr. 1, 2014.

(51) Int. Cl. G06Q 30/02; G06N 5/04

(52) U.S. Cl. CPC G06Q 30/0211; G06N 5/04

(57) ABSTRACT

Systems, methods and techniques disclosed herein provide dynamic time-based adjustment of predictive modeling data.

### CROSS-REFERENCE TO RELATED APPLICATIONS

This application is a continuation of and claims priority to U.S. application Ser. No. 14/675,125, titled “TIME-ADJUSTED DYNAMIC PROMOTION ANALYTICS,” filed Mar. 31, 2015, which claims the benefit of U.S. Provisional Application No. 61/973,815, entitled TIME-ADJUSTED DYNAMIC PROMOTION ANALYTICS, filed Apr. 1, 2014.

### TECHNICAL FIELD

Embodiments of the invention relate generally to offering promotions to consumers by a promotion and marketing service.

### BACKGROUND

Certain conventional techniques for recommending a promotion to consumers involve assessing the past performance of the same promotion or similar promotions. However, such conventional techniques do not account for the degradation of the performance of a promotion over its lifetime and, as such, result in an overestimation of the performance of less recent offers of the promotion. Through applied effort, ingenuity and innovation, solutions to improve such techniques have been realized and are described in connection with embodiments of the present invention.

### SUMMARY

In accordance with one exemplary embodiment, an apparatus is provided. The apparatus comprises at least one processor and at least one memory including computer program code. The at least one memory and the computer program code are configured to, with the at least one processor, cause the apparatus to at least generate a first graphical interface configured for display via electronic interfaces of client devices during a first network time interval. The first graphical interface is configured to render visual display elements via the electronic interfaces of the client devices. The at least one memory and the computer program code are further configured to, with the processor, cause the apparatus to transmit the first graphical interface to the client devices during the first network time interval. The at least one memory and the computer program code are further configured to, with the processor, cause the apparatus to receive electronic interface interaction signals, representing interactions performed by the client devices with the visual display elements via the first graphical interface. The at least one memory and the computer program code are further configured to, with the processor, cause the apparatus to generate, based on the electronic interface interaction signals, one or more electronic interface interaction attributes representing data associated with the interactions.

The at least one memory and the computer program code are further configured to, with the processor, cause the apparatus to generate one or more transformed electronic interface interaction attributes based at least in part on a first dynamic time-based adjustment of a number of the electronic interface interaction signals via the first graphical interface during the first network time interval and a second dynamic time-based adjustment of a number of defined interaction types during the first network time interval. The one or more transformed electronic interface attributes comprises at least a subset of the one or more electronic interface interaction attributes. Furthermore, the first dynamic time-based adjustment is based at least in part on a first variable decay rate based on the number of the electronic interface interaction signals via the electronic interfaces during the first network time interval. The second dynamic time-based adjustment is based at least in part on a second variable decay rate based on the number of the defined interaction types via the first graphical interface during the first network time interval.

The at least one memory and the computer program code are further configured to, with the processor, cause the apparatus to apply a predictive model to the one or more transformed electronic interface interaction attributes. The predictive model is configured to generate an electronic interface interaction score representative of future electronic interface interactions during a future network time period that is different from the first network time interval. The at least one memory and the computer program code are further configured to, with the processor, cause the apparatus to determine that the electronic interface interaction score satisfies a defined electronic interface interaction score value. The at least one memory and the computer program code are further configured to, with the processor, cause the apparatus to generate a real-time graphical interface configured to render the visual display elements during the future network time period. The at least one memory and the computer program code are further configured to, with the processor, cause the apparatus to transmit the real-time graphical interface to a particular client device during the future network time period.

In accordance with another exemplary embodiment, a computer-implemented method is provided. The computer-implemented method provides for generating, by a device comprising a processor, a first graphical interface configured for display via electronic interfaces of client devices during a first network time interval. The first graphical interface is configured to render visual display elements via the electronic interfaces of the client devices. The computer-implemented method also provides for transmitting, by the device, the first graphical interface to the client devices during the first network time interval. The computer-implemented method also provides for receiving, by the device, electronic interface interaction signals, representing interactions performed by the client devices with the visual display elements via the first graphical interface. The computer-implemented method also provides for generating, by the device and based on the electronic interface interaction signals, one or more electronic interface interaction attributes representing data associated with the interactions.

The computer-implemented method also provides for generating, by the device, one or more transformed electronic interface interaction attributes based at least in part on a first dynamic time-based adjustment of a number of the electronic interface interaction signals via the first graphical interface during the first network time interval and a second dynamic time-based adjustment of a number of defined interaction types during the first network time interval. The one or more transformed electronic interface attributes comprises at least a subset of the one or more electronic interface interaction attributes. Furthermore, the first dynamic time-based adjustment is based at least in part on a first variable decay rate based on the number of the electronic interface interaction signals via the electronic interfaces during the first network time interval. The second dynamic time-based adjustment is based at least in part on a second variable decay rate based on the number of the defined interaction types via the first graphical interface during the first network time interval.

The computer-implemented method also provides for applying, by the device, a predictive model to the one or more transformed electronic interface interaction attributes. The predictive model is configured to generate an electronic interface interaction score representative of future electronic interface interactions during a future network time period that is different from the first network time interval. The computer-implemented method also provides for determining, by the device, that the electronic interface interaction score satisfies a defined electronic interface interaction score value. The computer-implemented method also provides for generating, by the device, a real-time graphical interface configured to render the visual display elements during the future network time period. The computer-implemented method also provides for transmitting, by the device, the real-time graphical interface to a particular client device during the future network time period.

In accordance with yet another exemplary embodiment, a computer program product is provided. The computer program product is stored on a computer readable medium. The computer program product also comprises instructions that when executed by one or more computers cause the one or more computers to at least generate a first graphical interface configured for display via electronic interfaces of client devices during a first network time interval. The first graphical interface is configured to render visual display elements via the electronic interfaces of the client devices. The computer program product also comprises instructions that when executed by one or more computers cause the one or more computers to transmit the first graphical interface to the client devices during the first network time interval. The computer program product also comprises instructions that when executed by one or more computers cause the one or more computers to receive electronic interface interaction signals, representing interactions performed by the client devices with the visual display elements via the first graphical interface. The computer program product also comprises instructions that when executed by one or more computers cause the one or more computers to generate, based on the electronic interface interaction signals, one or more electronic interface interaction attributes representing data associated with the interactions.

The computer program product also comprises instructions that when executed by one or more computers cause the one or more computers to generate one or more transformed electronic interface interaction attributes based at least in part on a first dynamic time-based adjustment of a number of the electronic interface interaction signals via the first graphical interface during the first network time interval and a second dynamic time-based adjustment of a number of defined interaction types during the first network time interval. The one or more transformed electronic interface attributes comprises at least a subset of the one or more electronic interface interaction attributes. Furthermore, the first dynamic time-based adjustment is based at least in part on a first variable decay rate based on the number of the electronic interface interaction signals via the electronic interfaces during the first network time interval. The second dynamic time-based adjustment is based at least in part on a second variable decay rate based on the number of the defined interaction types via the first graphical interface during the first network time interval.

The computer program product also comprises instructions that when executed by one or more computers cause the one or more computers to apply a predictive model to the one or more transformed electronic interface interaction attributes. The predictive model is configured to generate an electronic interface interaction score representative of future electronic interface interactions during a future network time period that is different from the first network time interval. The computer program product also comprises instructions that when executed by one or more computers cause the one or more computers to determine that the electronic interface interaction score satisfies a defined electronic interface interaction score value. The computer program product also comprises instructions that when executed by one or more computers cause the one or more computers to generate a real-time graphical interface configured to render the visual display elements during the future network time period. The computer program product also comprises instructions that when executed by one or more computers cause the one or more computers to transmit the real-time graphical interface to a particular client device during the future network time period.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

The present invention may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 illustrates an overview for a promotion system configured to offer and accept promotions for promotion programs in accordance with some embodiments discussed herein;

FIG. 2 is a flowchart illustrating an exemplary computer-executed method for recommending a promotion to a consumer in accordance with some embodiments discussed herein; and

FIG. 3 illustrates a schematic block diagram of circuitry that can be included in a computing device, such as a promotion offering system, in accordance with some embodiments discussed herein.

### DETAILED DESCRIPTION

The capability to recommend promotions with a high predicted performance or a high predicted consumer acceptance is important as it increases the likelihood that consumers will purchase the promotions and thereby the likelihood of improved business metrics associated with the sale of the promotions. As such, exemplary systems, methods and techniques disclosed herein are configured to predict a future performance or a future consumer acceptance of a promotion based on past data on the performance of the same promotion or one or more similar promotions.

One or more predictive models may use the past performance data as input and generate an indication of the predicted performance and/or the predicted consumer acceptance of a promotion. The past performance data may include data on an indication of the commercial performance and/or consumer acceptance of a promotion including, but not limited to, the number of offers of a promotion that were purchased, the percentage of promotion offers that were purchased, the number of consumers who purchased a promotion, the percentage of consumers who were offered a promotion that purchased the promotion, the revenue and/or profit generated from the sale of a promotion, the conversion rate over time (i.e., the number of purchases divided by the number of impressions offered), and the like. The past performance data for a promotion may span a time period during which the promotion was offered and was available for purchase, i.e., the promotion program duration. Details on exemplary predictive models and their use in recommending promotions in exemplary embodiments are provided in U.S. patent application Ser. No. 13/839,360, filed Mar. 15, 2013, entitled “Dynamic Promotion Analytics,” the entire contents of which are hereby expressly incorporated herein by reference.

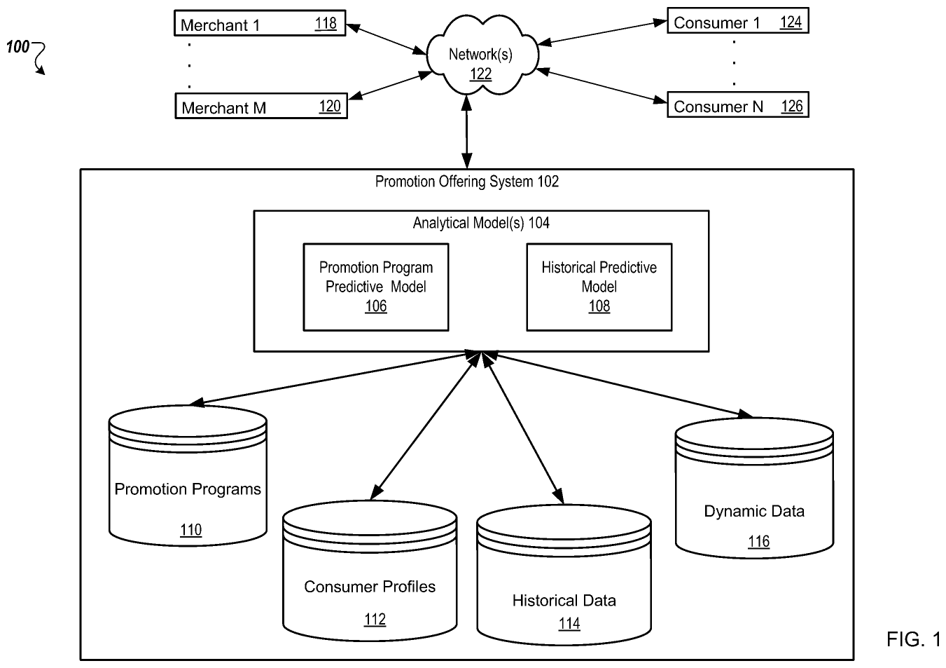

FIG. 1 illustrates an overview for a promotion system 100 configured to offer and accept promotions for promotion programs. The promotion system 100 includes a promotion offering system 102, which communicates via one or more networks 122 with consumers, such as consumer 1 (124) to consumer N (126), and with merchants, such as merchant 1 (118) to merchant M (120). The promotion offering system 102 includes an analytical model 104, which may include one or more analytical models. As illustrated in FIG. 1, the analytical model 104 is shown to include a dynamic analytical model 106 and a predictive analytical model 108. Although FIG. 1 is illustrated to show separate analytical models within the analytical model 104, FIG. 1 is merely provided for illustrative purposes and it is within the scope of the invention to have the functionality of all the analytical models be performed by a same computing machine, or separate computing machines.

The analytical models 104 communicate with multiple databases that are part of the promotion offering system 102 such as a promotion program database 110, consumer profiles database 112, historical data database 114 and dynamic data database 116. Specifically, the predictive analytical model 108 and dynamic analytical model 106 may access the databases 110, 112, 114 and 116 in order to generate information to be used in determining a probability that a consumer will accept an offer from a promotion program, as will be described in further detail throughout this disclosure.

The promotion program database 110 is responsible for storing data detailing various promotion programs that are available for offer in the promotion offering system 102. In order to input promotion program information into the promotion program database 110, merchants communicate via the networks 122 with the promotion offering system 102 to input the information detailing the various promotion program offerings.

The consumer profiles database 112 includes profiles for the consumers, consumer 1 (124) to consumer N (126), that are included in the promotion system 100. The information detailed for a consumer stored in the consumer profiles database 112 may include, but is not limited to, name, age, address, occupation, educational background, previously accepted promotion program offerings, previously rejected promotion program offerings, gender and the like. Any one, some or all of the attributes of the consumer may be used by the promotion offering system 102 in determining whether to offer a promotion to a consumer.

The historical data database 114 includes information detailing the past performance of promotion program offerings that have been presented in the promotion program system 102 in previous time periods. The historical data database 114 may include, but is not limited to, a number of offers from a promotion program that were presented to consumers, a number of acceptances of an offer from a promotion program, rates of acceptances of specific promotion programs, attributes of consumers that accepted or rejected specific promotion programs, and the like.

The dynamic data database 116 includes information detailing the past performance of a promotion program offering that is currently active in the promotion offering system 102. So that while a promotion program referenced in the dynamic data database 116 is currently active, the data stored in the dynamic data database 116 pertains to performance data of the active promotion program from a previous time period.

Although FIG. 1 has been illustrated to show separate databases 110, 112, 114 and 116, FIG. 1 has been illustrated for demonstrative purposes only, and it is within the scope of the present invention to have the databases 110, 112, 114 and 116 arranged in any combination of one or more memories/storage units.

Studies have shown that the performance of a promotion often tends to decay over time and not remain substantially linear or constant. Thus, using the aggregate performance data on the offers of a promotion may result in an overestimation in a predicted future performance of the promotion. That is, less recent data points may have an exaggerated effect on performance predicted from the aggregate performance data. To mitigate this effect and improve the accuracy of predicted performance, in certain exemplary non-limiting embodiments, the raw past performance data may be adjusted or transformed to generate adjusted past performance data that takes into account the decaying or decreasing trend in the performance of a promotion. In some embodiments, the adjusted past performance data may discount, or discount more heavily, less recent past performance data. In some embodiments, the adjusted past performance data may be weighted more heavily for more recent past performance data points.

As an example, for a promotion program duration over the month of April 2014, the performance data may indicate that a conversion rate of 0.5 for the first week of April 2014, a conversion rate of 0.3 for the second week of April 2014, a conversion rate of 0.2 for the third week of April, and a conversion rate of 0.1 for the fourth week of April 2014. In this case, the performance of the promotion (in terms of the conversion rate) degraded, decayed or decreased over time, indicating that the performance of this promotion tends to decay over time and not remain substantially linear or constant. Thus, using the aggregate conversion rate over the month of April may result in an overestimation in a predicted future performance of the promotion. In one embodiment, performance data from a most recent portion of the promotion program duration (e.g., the last day of April 2014) may be used without weighting or discounting, while performance data from the remaining less recent portion of the promotion program duration may be used with a discounting or decay rate applied to the performance data. A scaling factor may be applied to scale down the older or less recent performance data, instead of aggregating performance data and statistics over a specified time window. The dynamic adjustment of the less recent data enables exemplary embodiments to generate a more accurate prediction of the future performance of the promotion.

Presented below is an exemplary non-limiting formula for the dynamic time-based adjustment of the number of impressions of a promotion in the past performance data:

dimpsᵢ=impsᵢ+αⱼdimpsᵢ₋₁

where, i indicates a time period within the promotion program duration (e.g., the most recent day), dimps represents the adjusted number of impressions offered for a promotion for use in a predictive model, imps represents the raw number of impressions offered for a promotion, a represents a decay rate, and j represents a choice of a specific decay rate.

In one example, the dimpsᵢ value may be calculated at certain time intervals (e.g., every day). For example, on day 1, dimps₁ may be set to the raw imps₁ data; on day 2, dimps₂ may be calculated from the raw imps₂ data and a decayed measure of the calculated dimps₁ data; and the like.

In another example, on an nth day, dimpsₙ may be calculated in one step based on the raw impsₙ data and decayed measures of the past time-adjusted dimps data. As a specific non-limiting numerical example, if today is the third day that a promotion has been offered and if 100 impressions were offered on the first day, 200 impressions were offered on the second day and 300 impressions were offered on the third day, and if the decay rate (a) is 0.99, then the time-adjusted number of impressions on the third day may be calculated as:

dimps₃=300+0.99dimps2=300+0.99(200+0.99dimps1))=300+0.99(200+0.99*(100))

Presented below is an exemplary non-limiting formula for the dynamic time-based adjustment of the number of purchases of a promotion in the past performance data:

dqtyᵢ=qtyᵢ+αⱼdqtyᵢ₋₁

where, i indicates a time period within the promotion program duration (e.g., the most recent day), dqty represents the adjusted number of purchases of a promotion for use in a predictive model, qty represents the raw number of purchases of a promotion, a represents a decay rate, and j represents a choice of a specific decay rate.

In one example, the dqty₁ value may be calculated at certain time intervals (e.g., every day). For example, on day 1, dqty₁ may be set to the raw qty₁ data; on day 2, dqty₂ may be calculated from the raw qty₂ data and a decayed measure of the calculated dqty₁ data; and the like.

In another example, on an nth day, dqtyₙ may be calculated in one step based on the raw qtyₙ data and decayed measures of the past time-adjusted dqty data.

In one exemplary embodiment, upon generating a time-adjusted number of purchases for a promotion (dqty) and a time-adjusted number of impressions of the promotion offered (dimp), the time-adjusted numbers may be used to generate a time-adjusted conversion rate (dqty/dimp). The time-adjusted conversion rate is an indication of past consumer acceptance, performance or success of the promotion. The time-adjusted conversion rate may then be input into a predictive model for predicting a future consumer acceptance, performance or success of the same promotion or a similarly promotion.

Certain exemplary embodiments may generate or receive a suitable decay rate (a) for application in the exemplary formulae for determining the adjusted past performance data. A specific decay rate may be associated with a specific half-life, i.e., the number of time periods over which the original counts are halved. For example, to obtain an exemplary half-life of 30 days by using daily decays, an exemplary non-limiting decay rate of about 0.97716 may be used. In certain embodiments, the decay rate may be adjusted or controlled during the generation of the adjusted performance data. The use of a different decay rates may make it possible to use different decayed estimates that weight the relative importance of old data versus new data differently. This may allow for greater flexibility in the predictive model.

Exemplary embodiments may also enable the control or adjustment of the decay period, i. Therefore, decays can be applied more frequently than once a day, once a day, or less frequently than once a day. In some cases, with adjustment of the decay period, the decay rate may be adjusted accordingly.

In certain exemplary non-limiting embodiments, the past performance data may be weighted or discounted based on the recency of each data point. In these embodiments, the commercial performance data points and/or consumer acceptance data points may be associated with a particular time or time period within the promotion program duration during which the data is applicable. To this end, the promotion program duration may be divided into one or more time periods that are suitably granular for the predictive models. Each of the divided time periods may be associated with commercial performance data and/or consumer acceptance data that are relevant to that particular time period. The recency of the time periods may then be used to weight or discount the performance data that is relevant to the time periods. The weighted or discounted performance data may then be aggregated for use in a predictive model that predicts a future predicted performance of the promotion.

As an example, for a promotion program duration over the month of April 2014, the performance data may indicate that a total of 100 offers of a promotion resulted in a purchase of which 80 were sold in the first week of April 2014, 10 were sold in the second week of April 2014, 10 were sold in the third week of April, and none were sold in the fourth week of April 2014. In this case, the performance of the promotion (in terms of number of offers that result in purchase) decreased over time and, therefore, indicates that the performance of this promotion tends to decay over time and not remain substantially linear or constant. Thus, using the aggregate performance data of a 100 offers sold may result in an overestimation in a predicted future performance of the promotion. In one embodiment, the more recent performance data (for example, from the last two weeks of April 2014) may be weighted more heavily and/or may be less discounted than the less recent data (for example, from the first two weeks of April 2014). This discounting of less recent data enables the predictive model to more accurately predict the future performance of the promotion by considering the decaying trend of the performance of the promotion.

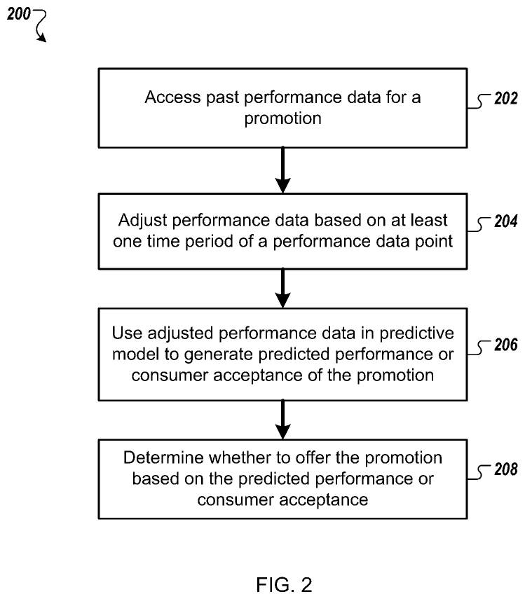

FIG. 2 is a flowchart illustrating an exemplary computer-executed method for recommending a promotion to a consumer. In step 202, performance data of the promotion for a promotion program duration is accessed. The promotion program duration may be the duration during which the promotion was offered to consumers in the past. During the promotion program duration, the promotion may have been offered one or more times to one or more consumers. Each offer of the promotion may be indicated by the transmission of a corresponding impression to a consumer. For example, a first impression of the promotion transmitted to a first consumer may count as one offer of the promotion, while a second impression of the promotion transmitted to the first consumer or to a second consumer may count as another offer.

In certain embodiments, the performance data may include past or historical data on an indication of consumer acceptance or performance of the promotion. In certain embodiments, the performance data may include past or historical data on an indication of consumer acceptance or performance of similar promotions (e.g., promotions offered in the same category in the same price range). The performance data may also include data on one or more attributes of the promotion. These attributes may include and/or may be derived from one or more consumer attributes and/or one or more promotion attributes. Exemplary consumer attributes may include, but are not limited to, an age, a gender, a geographical location, a geographical distance from the offer, a price preference, a brand preference, a merchant preference, and a prior purchase. Exemplary promotion attributes may include, but are not limited to, a price, a discount, a geographical location, a promotion category, a promotion sub-category, a brand, and a merchant.

In step 204, the data on the indication of consumer acceptance or performance of a first offer of the promotion may be adjusted based on a first time period of the data on the first offer. For example, if the first offer of the promotion was purchased in the first week of April 2014, this time period may be used to adjust how the corresponding data point is weighted or discounted. Any of the weighting, discounting or scaling techniques disclosed herein may be used in step 204. One or more additional data points in the performance data may be adjusted accordingly. For example if a second offer of the promotion was purchased in the second week of April 2014, this time period may be used to adjust the corresponding data point is weighted or discounted.

In certain embodiments, a decay rate may be associated with a time period for a data point in the performance data. The decay rate may be constant or variable for different time periods associated with different data points. The decay rate may be used to adjust the performance data before use in predicting future performance of the promotion.

In step 206, after adjustment, the performance data may be used by a predictive model to automatically generate an indication of predicted consumer acceptance or predicted performance of the promotion. Details on exemplary predictive models and their use in recommending promotions in exemplary embodiments are provided in U.S. patent application Ser. No. 13/839,360, filed Mar. 15, 2013, titled “Dynamic Promotion Analytics,” the entire contents of which are hereby expressly incorporated herein by reference.

In step 208, based on the generated predicted consumer acceptance or predicted performance, exemplary embodiments may determine whether to offer the promotion to a consumer. In one embodiment, the promotion may be offered to a consumer only if the predicted consumer acceptance or predicted performance is above a predetermined threshold value. Subsequently, one or more computer-executable instructions may be transmitted to a computing device associated with the consumer (e.g., a mobile computing device) to cause the device to render an impression associated with the promotion as an offer of the promotion to the consumer. The impression may be rendered visually on a visual display of the computing device in one embodiment.

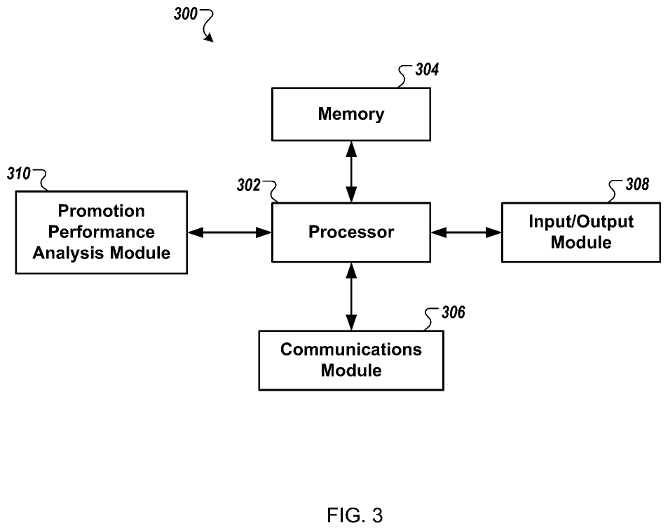

FIG. 3 shows a schematic block diagram of circuitry 300, some or all of which may be included in, for example, promotion offering system 102. As illustrated in FIG. 3, in accordance with some example embodiments, circuitry 300 can include various means, such as processor 302, memory 304, communications module 306, and/or input/output module 308. As referred to herein, “module” includes hardware, software and/or firmware configured to perform one or more particular functions. In this regard, the means of circuitry 300 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 304) that is executable by a suitably configured processing device (e.g., processor 302), or some combination thereof.

Processor 302 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments processor 302 comprises a plurality of processors. The plurality of processors may be embodied on a single computing device or may be distributed across a plurality of computing devices collectively configured to function as circuitry 300. The plurality of processors may be in operative communication with each other and may be collectively configured to perform one or more functionalities of circuitry 300 as described herein. In an example embodiment, processor 302 is configured to execute instructions stored in memory 304 or otherwise accessible to processor 302. These instructions, when executed by processor 302, may cause circuitry 300 to perform one or more of the functionalities of circuitry 300 as described herein.

Whether configured by hardware, firmware/software methods, or by a combination thereof, processor 302 may comprise an entity capable of performing operations according to embodiments of the present invention while configured accordingly. Thus, for example, when processor 302 is embodied as an ASIC, FPGA or the like, processor 302 may comprise specifically configured hardware for conducting one or more operations described herein. Alternatively, as another example, when processor 302 is embodied as an executor of instructions, such as may be stored in memory 304, the instructions may specifically configure processor 302 to perform one or more algorithms and operations described herein, such as those discussed in connection with FIG. 1.

Memory 304 may comprise, for example, volatile memory, non-volatile memory, or some combination thereof. Although illustrated in FIG. 3 as a single memory, memory 304 may comprise a plurality of memory components. The plurality of memory components may be embodied on a single computing device or distributed across a plurality of computing devices. In various embodiments, memory 304 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 304 may be configured to store information, data (including analytics data), applications, instructions, or the like for enabling circuitry 300 to carry out various functions in accordance with example embodiments of the present invention. For example, in at least some embodiments, memory 304 is configured to buffer input data for processing by processor 302. Additionally or alternatively, in at least some embodiments, memory 304 is configured to store program instructions for execution by processor 302. Memory 304 may store information in the form of static and/or dynamic information. This stored information may be stored and/or used by circuitry 300 during the course of performing its functionalities.

Communications module 306 may be embodied as any device or means embodied in circuitry, hardware, a computer program product comprising computer readable program instructions stored on a computer readable medium (e.g., memory 304) and executed by a processing device (e.g., processor 302), or a combination thereof that is configured to receive and/or transmit data from/to another device, such as, for example, a second circuitry 300 and/or the like. In some embodiments, communications module 306 (like other components discussed herein) can be at least partially embodied as or otherwise controlled by processor 302. In this regard, communications module 306 may be in communication with processor 302, such as via a bus. Communications module 306 may include, for example, an antenna, a transmitter, a receiver, a transceiver, network interface card and/or supporting hardware and/or firmware/software for enabling communications with another computing device. Communications module 306 may be configured to receive and/or transmit any data that may be stored by memory 304 using any protocol that may be used for communications between computing devices. Communications module 306 may additionally or alternatively be in communication with the memory 304, input/output module 308 and/or any other component of circuitry 300, such as via a bus.

Input/output module 308 may be in communication with processor 302 to receive an indication of a user input and/or to provide an audible, visual, mechanical, or other output to a user. Some example visual outputs that may be provided to a user by circuitry 300 are discussed in connection with FIG. 1. As such, input/output module 308 may include support, for example, for a keyboard, a mouse, a joystick, a display, a touch screen display, a microphone, a speaker, a RFID reader, barcode reader, biometric scanner, and/or other input/output mechanisms. In embodiments wherein circuitry 300 is embodied as a server or database, aspects of input/output module 308 may be reduced as compared to embodiments where circuitry 300 is implemented as an end-user machine or other type of device designed for complex user interactions. In some embodiments (like other components discussed herein), input/output module 308 may even be eliminated from circuitry 300. Alternatively, such as in embodiments wherein circuitry 300 is embodied as a server or database, at least some aspects of input/output module 308 may be embodied on an apparatus used by a user that is in communication with circuitry 300. Input/output module 308 may be in communication with the memory 304, communications module 306, and/or any other component(s), such as via a bus. Although more than one input/output module and/or other component can be included in circuitry 300, only one is shown in FIG. 3 to avoid overcomplicating the drawing (like the other components discussed herein).

Promotion performance analysis module 310 may also or instead be included and configured to perform the functionality discussed herein related to the promotion performance analysis discussed above. In some embodiments, some or all of the functionality of promotion performance analysis may be performed by processor 302. In this regard, the example processes and algorithms discussed herein can be performed by at least one processor 302 and/or promotion performance analysis module 310. For example, non-transitory computer readable media can be configured to store firmware, one or more application programs, and/or other software, which include instructions and other computer-readable program code portions that can be executed to control each processor (e.g., processor 302 and/or promotion performance analysis module 310) of the components of system 102 to implement various operations, including the examples shown above. As such, a series of computer-readable program code portions are embodied in one or more computer program products and can be used, with a computing device, server, and/or other programmable apparatus, to produce machine-implemented processes.

Any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of system 102. In some embodiments, one or more external systems (such as a remote cloud computing and/or data storage system) may also be leveraged to provide at least some of the functionality discussed herein.

As described above in this disclosure, aspects of embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

In describing exemplary embodiments, specific terminology is used for the sake of clarity. For purposes of description, each specific term is intended, at least, to include all technical and functional equivalents that operate in a similar manner to accomplish a similar purpose. Additionally, in some instances where a particular exemplary embodiment includes a plurality of system elements or method steps, those elements or steps may be replaced with a single element or step. Likewise, a single element or step may be replaced with a plurality of elements or steps that serve the same purpose. Further, where parameters for various properties are specified herein for exemplary embodiments, those parameters may be adjusted up or down by 1/20th, 1/10th, ⅕th, ⅓rd, ½nd, and the like, or by rounded-off approximations thereof, unless otherwise specified. Moreover, while exemplary embodiments have been shown and described with references to particular embodiments thereof, those of ordinary skill in the art will understand that various substitutions and alterations in form and details may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than shown.

Blocks of the block diagram and the flow chart illustrations support combinations of means for performing the specified functions, combinations of steps for performing the specified functions and program instruction means for performing the specified functions. It will also be understood that some or all of the blocks/steps of the circuit diagram and process flowchart, and combinations of the blocks/steps in the circuit diagram and process flowcharts, can be implemented by special purpose hardware-based computer systems that perform the specified functions or steps, or combinations of special purpose hardware and computer instructions. Exemplary systems may include more or fewer modules than those illustrated in the exemplary block diagrams.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications, combinations and other embodiments are intended to be included within the scope of the appended claims. Although specific terms are employed herein, they are used in a generic and descriptive sense only and not for purposes of limitation.

That which is claimed is:

1. An apparatus comprising at least one processor and at least one memory including computer program code, the at least one memory and the computer program code configured to, with the at least one processor, cause the apparatus to at least:
generate a first graphical interface configured for display via electronic interfaces of client devices during a first network time interval, wherein the first graphical interface is configured to render visual display elements via the electronic interfaces of the client devices;
transmit the first graphical interface to the client devices during the first network time interval;
receive electronic interface interaction signals, representing interactions performed by the client devices with the visual display elements via the first graphical interface;
generate, based on the electronic interface interaction signals, one or more electronic interface interaction attributes representing data associated with the interactions;
generate one or more transformed electronic interface interaction attributes based at least in part on a first dynamic time-based adjustment of a number of the electronic interface interaction signals via the first graphical interface during the first network time interval and a second dynamic time-based adjustment of a number of defined interaction types during the first network time interval, wherein the one or more transformed electronic interface attributes comprises at least a subset of the one or more electronic interface interaction attributes, wherein the first dynamic time-based adjustment is based at least in part on a first variable decay rate based on the number of the electronic interface interaction signals via the electronic interfaces during the first network time interval, and wherein the second dynamic time-based adjustment is based at least in part on a second variable decay rate based on the number of the defined interaction types via the first graphical interface during the first network time interval;
apply a predictive model to the one or more transformed electronic interface interaction attributes, wherein the predictive model is configured to generate an electronic interface interaction score representative of future electronic interface interactions during a future network time period that is different from the first network time interval;
determine that the electronic interface interaction score satisfies a defined electronic interface interaction score value;
generate a real-time graphical interface configured to render the visual display elements during the future network time period; and
transmit the real-time graphical interface to a particular client device during the future network time period.

2. The apparatus of claim 1, wherein the at least one memory and the computer program code are further configured to, with the processor, cause the apparatus to:
retrieve, from a data repository, one or more user identifier attributes associated with a user identifier associated with the electronic interface interaction signals via the first graphical interface; and
apply the predictive model to the one or more user identifier attributes.

3. The apparatus of claim 1, wherein the at least one memory and the computer program code are further configured to, with the processor, cause the apparatus to:
retrieve, from a data repository, one or more location attributes representing a geographical location associated with the client devices; and
apply the predictive model to the one or more location attributes.

4. The apparatus of claim 1, wherein the at least one memory and the computer program code are further configured to, with the processor, cause the apparatus to:
retrieve, from a data repository, one or more entity attributes representing an entity identifier associated with the visual display elements; and
apply the predictive model to the one or more entity attributes.

5. The apparatus of claim 1, wherein the at least one memory and the computer program code are further configured to, with the processor, cause the apparatus to:
retrieve, from a data repository, one or more visual display element attributes associated with the visual display elements; and
apply the predictive model to the one or more visual display element attributes.

6. The apparatus of claim 1, wherein the particular client device is a mobile computing device, and wherein the at least one memory and the computer program code are further configured to, with the processor, cause the apparatus to:
cause the display of the real-time graphical interface via the mobile computing device.

7. The apparatus of claim 1, wherein the at least one memory and the computer program code are further configured to, with the processor, cause the apparatus to:
dynamically update the predictive model during the first network time interval and based on the one or more electronic interface interaction attributes.

8. A computer-implemented method, comprising:
generating, by a device comprising a processor, a first graphical interface configured for display via electronic interfaces of client devices during a first network time interval, wherein the first graphical interface is configured to render visual display elements via the electronic interfaces of the client devices;
transmitting, by the device, the first graphical interface to the client devices during the first network time interval;
receiving, by the device, electronic interface interaction signals, representing interactions performed by the client devices with the visual display elements via the first graphical interface;
generating, by the device and based on the electronic interface interaction signals, one or more electronic interface interaction attributes representing data associated with the interactions;
generating, by the device, one or more transformed electronic interface interaction attributes based at least in part on a first dynamic time-based adjustment of a number of the electronic interface interaction signals via the first graphical interface during the first network time interval and a second dynamic time-based adjustment of a number of defined interaction types during the first network time interval, wherein the one or more transformed electronic interface attributes comprises at least a subset of the one or more electronic interface interaction attributes, wherein the first dynamic time-based adjustment is based at least in part on a first variable decay rate based on the number of the electronic interface interaction signals via the electronic interfaces during the first network time interval, and wherein the second dynamic time-based adjustment is based at least in part on a second variable decay rate based on the number of the defined interaction types via the first graphical interface during the first network time interval;
applying, by the device, a predictive model to the one or more transformed electronic interface interaction attributes, wherein the predictive model is configured to generate an electronic interface interaction score representative of future electronic interface interactions during a future network time period that is different from the first network time interval;
determining, by the device, that the electronic interface interaction score satisfies a defined electronic interface interaction score value;
generating, by the device, a real-time graphical interface configured to render the visual display elements during the future network time period; and
transmitting, by the device, the real-time graphical interface to a particular client device during the future network time period.

9. The computer-implemented method of claim 8, further comprising:
retrieving, by the device and from a data repository, one or more user identifier attributes associated with a user identifier associated with the electronic interface interaction signals via the first graphical interface; and
applying, by the device, the predictive model to the one or more user identifier attributes.

10. The computer-implemented method of claim 8, further comprising:
retrieving, by the device and from a data repository, one or more location attributes representing a geographical location associated with the client devices; and
applying, by the device, the predictive model to the one or more location attributes.

11. The computer-implemented method of claim 8, further comprising:
retrieving, by the device and from a data repository, one or more entity attributes representing an entity identifier associated with the visual display elements; and
applying, by the device, the predictive model to the one or more entity attributes.

12. The computer-implemented method of claim 8, further comprising:
retrieving, by the device and from a data repository, one or more visual display element attributes associated with the visual display elements; and
applying, by the device, the predictive model to the one or more visual display element attributes.

13. The computer-implemented method of claim 8, wherein the particular client device is a mobile computing device, and the computer-implemented method further comprising:
causing, by the device, the display of the real-time graphical interface via the mobile computing device.

14. The computer-implemented method of claim 8, further comprising:
dynamically updating, by the device, the predictive model during the first network time interval and based on the one or more electronic interface interaction attributes.

15. A computer program product, stored on a computer readable medium, comprising instructions that when executed by one or more computers cause the one or more computers to:
generate a first graphical interface configured for display via electronic interfaces of client devices during a first network time interval, wherein the first graphical interface is configured to render visual display elements via the electronic interfaces of the client devices;
transmit the first graphical interface to the client devices during the first network time interval;
receive electronic interface interaction signals, representing interactions performed by the client devices with the visual display elements via the first graphical interface;
generate, based on the electronic interface interaction signals, one or more electronic interface interaction attributes representing data associated with the interactions;
generate one or more transformed electronic interface interaction attributes based at least in part on a first dynamic time-based adjustment of a number of the electronic interface interaction signals via the first graphical interface during the first network time interval and a second dynamic time-based adjustment of a number of defined interaction types during the first network time interval, wherein the one or more transformed electronic interface attributes comprises at least a subset of the one or more electronic interface interaction attributes, wherein the first dynamic time-based adjustment is based at least in part on a first variable decay rate based on the number of the electronic interface interaction signals via the electronic interfaces during the first network time interval, and wherein the second dynamic time-based adjustment is based at least in part on a second variable decay rate based on the number of the defined interaction types via the first graphical interface during the first network time interval;
apply a predictive model to the one or more transformed electronic interface interaction attributes, wherein the predictive model is configured to generate an electronic interface interaction score representative of future electronic interface interactions during a future network time period that is different from the first network time interval;
determine that the electronic interface interaction score satisfies a defined electronic interface interaction score value;
generate a real-time graphical interface configured to render the visual display elements during the future network time period; and
transmit the real-time graphical interface to a particular client device during the future network time period.

16. The computer program product of claim 15, wherein the computer program product further comprises instructions that when executed by the one or more computers cause the one or more computers to:
retrieve, from a data repository, one or more user identifier attributes associated with a user identifier associated with the electronic interface interaction signals via the first graphical interface; and
apply the predictive model to the one or more user identifier attributes.

17. The computer program product of claim 15, wherein the computer program product further comprises instructions that when executed by the one or more computers cause the one or more computers to:
retrieve, from a data repository, one or more location attributes representing a geographical location associated with the client devices; and
apply the predictive model to the one or more location attributes.

18. The computer program product of claim 15, wherein the computer program product further comprises instructions that when executed by the one or more computers cause the one or more computers to:
retrieve, from a data repository, one or more entity attributes representing an entity identifier associated with the visual display elements; and
apply the predictive model to the one or more entity attributes.

19. The computer program product of claim 15, wherein the computer program product further comprises instructions that when executed by the one or more computers cause the one or more computers to:
retrieve, from a data repository, one or more visual display element attributes associated with the visual display elements; and
apply the predictive model to the one or more visual display element attributes.

20. The computer program product of claim 15, wherein the computer program product further comprises instructions that when executed by the one or more computers cause the one or more computers to:
dynamically update the predictive model during the first network time interval and based on the one or more electronic interface interaction attributes.
